(19) United States
(12) Patent Application Publication
(10) Pub. No.: US 2026/0257384 A1
(43) Pub. Date: Sep. 3, 2026

(54) GRIPPING DEVICE FOR COMBINED CONTAINER ALIGNMENT AND TRANSPORT DEVICE

(71) Applicant: KRONES AG, Neutraubling (DE)

(72) Inventor: Max BRIKMANN, Thalmassing (DE)

(21) Appl. No.: 18/994,834

(22) PCT Filed: Mar. 27, 2023
(86) PCT No.: PCT/EP2023/057801

§ 371 Date: Jan. 15, 2025

(30) Foreign Application Priority Data
Jul. 15, 2022 (DE) 10 2022 117 749.1

(51) Int. Cl. B25J 21/00; B25J 19/00; F16J 15/52

(52) U.S. Cl. CPC B25J 21/005; B25J 19/0075; F16J 15/52

(57) ABSTRACT

A gripping device includes a carrier; a gripping element which is movable with respect to the carrier for gripping a container during transport thereof along a transport path arranged at least in portions inside a clean room; a first drive device for rotating a shaft connected to a gripping element; and at least one second drive device for shifting the gripping element with respect to the carrier. The first drive device and the second drive device are arranged outside the clean room, wherein a clean room boundary extends between the carrier and the gripping element which boundary is formed at least in portions by an at least partially movable sealing device which allows the transmission of a movement pulse generated outside the clean room from both the first drive device and the second drive device to the gripping element arranged inside the clean room while maintaining the clean room boundary.

### DESCRIPTION

The present invention relates to a gripping device for containers, such as those used in apparatuses and methods for heating and/or forming plastics preforms. Gripping devices which, for example, hold and guide plastics preforms within ovens in which they are heated for subsequent forming are known from the prior art. Such gripping devices are usually configured as grippers or holding mandrels which can pick up the plastics preforms in the region of the mouthpiece from the outside (gripper) or the inside (mandrel).

In particular when producing plastics containers with non-circular cross sections (with respect to the longitudinal direction of the container), the correct alignment of the container or the container preform (also referred to as preforms) is important. It is known from the prior art to also blow mold containers which have cross sections other than circular, such as oval cross sections. This is associated with problems because not only do blow molds have to be used that have cross sections deviating from circular cross sections, but the correct alignment of the preforms must also be taken into account even during heating in order to subject the preforms to a temperature profile along their circumferential direction suitable for the subsequent forming. For example, a heating method is known in which the plastics preform is exposed to a sinusoidal temperature distribution in the tangential direction.

An example of such an apparatus is known from WO 2021 122 712A 1 . It discloses an apparatus for producing oval containers. In order to produce, for example, oval containers of the appropriate quality from appropriately tempered preforms, the plastics preforms must be inserted into the blow mold in the correct position. This means that hot preform sides and long container sides as well as cold preform sides and short container sides must be correctly aligned with respect to the blow mold.

Furthermore, it is known from the prior art that preforms are transported under clean room conditions after being exposed to a temperature profile suitable for the forming process. This has the advantage that in order to achieve sterility (which may be achieved by applying heat), only the comparatively small surface of the preforms needs to be sterilized compared to formed containers. This results, for example, in a saving of time, a saving of sterilizing agent, a reduction in used sterilizing agent to be disposed of and/or a saving of energy.

The alignment of preforms with respect to their longitudinal axis during transport in a clean room is associated with particular difficulties. To avoid contamination of the clean room, the drive device by which alignment is achieved should not be arranged in the clean room.

Accordingly, the object of the present invention is to provide an apparatus and a method by which preforms or containers can be aligned within a clean room. In this case, contamination of the clean room by the drive device should be avoided.

Preferably, a holding device which holds the container to be transported at least in portions during its transport through the clean room should be easily replaceable in order to allow the apparatus and the method to be used for different container geometries. Changing between different holding devices when changing between different container geometries should be realizable as simply and quickly as possible.

This object is achieved on the apparatus side according to the features of claim 1. This object is achieved on the method side by the features of claim 9. Further advantageous embodiments and method variants are the subject matter of the dependent claims.

An essential aspect of the invention is therefore a gripping device which comprises:
a carrier,
a gripping element which is movable with respect to the carrier for gripping a container during the transport thereof along a transport path arranged at least in portions inside a clean room,
a first drive device for rotating a shaft connected to a gripping element, and
at least one second drive device for shifting the gripping element with respect to the carrier.

In this case, both the first drive device as well as the second drive device are arranged outside the clean room.

This gripping device is in particular characterized by the fact that a clean room boundary runs between the carrier and the gripping element. This is formed at least in portions by a sealing device which in turn is movable at least in portions. This sealing device allows the transmission of a movement pulse generated outside the clean room from both the first drive device and the second drive device to the gripping element arranged inside the clean room while maintaining the clean room boundary. This makes it possible to arrange the drives for the gripping element outside the clean room where they are easily accessible for maintenance work, for example. In addition, keeping the clean room clean is made easier because such complex geometric structures, which have many recesses that are difficult to access for some sterilizing agents, are arranged outside the clean room.

In a preferred embodiment, the shaft rotatable by the first drive device is shiftable with respect to the carrier in its longitudinal direction. Preferably, the first drive device with this shaft is shiftable in the longitudinal direction thereof. This preferably makes it possible for the shaft to be connectable directly to the drive device and for no flexible connecting elements to have to be arranged between the drive device and the shaft. Particularly preferably, the first drive device is an electric motor, for example a servo motor, whose motor shaft and/or rotor have an axis of rotation which is an extension of the longitudinal axis of the shaft. If necessary, the shaft can be an extension of the motor shaft and/or the rotor. For this purpose, the shaft and the motor shaft and/or an axle of the rotor could be formed as a single piece.

The embodiment of the first drive device as an electric motor also offers the advantage that only cables are required as a supply line. These can be configured to be flexible and, during the shifting of the drive device that is connected via the cable to the rotatable shaft with respect to the carrier, are therefore deformable in such a way that the electrical connection of the first drive device remains intact, and the shaft remains rotatable by the first drive device largely independent of the degree of shifting relative to the carrier.

Preferably, the possibility of configuring the first drive device with this shaft to be shiftable in the longitudinal direction thereof is ensured by the drive device being arranged on a first carriage which is shiftable in the longitudinal direction of the shaft by the second drive device. The guide of the carriage can (and is preferably) arranged offset in the radial direction with respect to the longitudinal extension of the shaft. The carriage is therefore guided on a path that extends parallel to the longitudinal axis of the shaft. By laterally offsetting the path on which the carriage is guided with respect to the shaft, a free and unhindered rotation of the shaft can be made possible.

Preferably, the shaft is surrounded at least in portions by a sleeve. This can additionally stabilize the shaft against shifting in the radial direction. Preferably, the sleeve is shiftable in the longitudinal direction of the shaft with respect to the carrier. The resulting advantages, in particular when triggering the release of a container from the gripping element, are explained in particular in connection with the description of the figures. The shaft and the sleeve are preferably shiftable independently of one another with respect to the carrier along the longitudinal direction of the shaft. As a result, and in particular by shifting the sleeve in the direction of the end of the shaft facing away from the first drive device, it is possible to release a container previously held by a gripping element connected to the shaft, for example to press the container out of a receptacle of the gripping element or to strip the container from a (for example an internally gripping) gripping element.

Preferably, the gripping element has an inner gripping element part and an outer gripping element part. The outer gripping element part surrounds the inner gripping element part at least in portions. Preferably, these two gripping element parts can be moved with respect to one another along the longitudinal direction of the inner gripping element part. The two gripping element parts therefore preferably continue the movement that is described above with respect to the shaft and the sleeve surrounding it (at least in portions).

In particular, it is preferred in this context for the inner gripping element part to be configured as a type of mandrel which can be inserted into a container at least in portions. Preferably, such a mandrel or the inner gripping element part contacts portions of the inside of the container at least temporarily in portions (for example while the container is held by the gripping device). By contacting the inside of the container, a force-fitting and/or form-fitting connection can be formed between the inner gripping element part and the container. Such a force-fitting and/or form-fitting connection allows a movement of the inner gripping element part to be transmitted to the container very precisely. This is particularly advantageous when a rotation of the container into a predetermined orientation with respect to its longitudinal direction is desired or required, for example in order to apply a temperature profile to it or to form it into a container with a non-circular cross section (with respect to its longitudinal direction).

Preferably, the outer gripping element part also contacts the container at least temporarily and/or in portions. Preferably, the outer gripping element part contacts portions of the outside of the container in portions. Preferred in particular, the outer gripping element part temporarily contacts the outer surface of the mouthpiece, the thread and/or a support ring.

The sealing device preferably has a flexible collar. The flexibility of this collar allows it to be fixed on the one hand (for example to a wall of the clean room), but on the other hand, it can however follow a movement of the shaft and/or the sleeve and therefore can permanently maintain the boundary between the clean room and the environment regardless of the position of the sleeve and/or collar. It is not necessary for the collar alone to form the clean room boundary between the wall and the movable sleeve and/or collar. Rather, it is conceivable that several elements such as a seal, a ball bearing and/or a “water lock” (a projection guided in a tank filled with liquid (in particular a sterilizing agent) and movable with respect to the tank) together form the clean room boundary.

In particular, it is preferred that the collar comprises a bellows or is a bellows. A bellows has proven to be very advantageous in order to be able to follow, at least in portions, a shifting of the sleeve and/or the shaft in the longitudinal direction thereof with respect to the clean room wall. The bellows and/or the collar preferably has a first portion which is immovable with respect to the carrier when the gripping device is in an operating state, and another second portion which is movable with respect to the carrier when the gripping device is in an operating state, preferably shiftable in the longitudinal direction of the shaft. Accordingly, the first portion can permanently ensure the seal with respect to the clean room wall, whereas the second portion can permanently ensure the seal with respect to the sleeve and/or shaft.

In a preferred embodiment, the sealing device comprises a ball bearing. This can (preferably in combination with other sealing elements such as the collar described above) on the one hand prevent or at least reduce the passage of contaminants through the sealing device, but on the other hand can allow the relative movement of the sleeve and/or the shaft with respect to the clean room wall, in particular a portion of the clean room wall which is immovable with respect to the carrier. Preferably, such a ball bearing allows both the shifting of the shaft and/or sleeve in its longitudinal direction as well as the rotation of the shaft and/or sleeve about its longitudinal axis. The ball bearing is preferably arranged between the shaft or a sleeve surrounding this shaft and a part immovable with respect to the carrier, preferably the clean room wall. Irrespective of this, it is preferred that the ball bearing surrounds the shaft and/or sleeve in a ring shape, which has proven to be very advantageous with respect to the bearing, guidance and stabilization of the shaft and/or sleeve during both of the above-mentioned relative movements (individually or in combination) with respect to the clean room wall.

In a preferred embodiment, a gear is arranged between the first drive and the shaft. Preferably, this gear offers a stepping down which allows precise positioning of the shaft and therefore also of the (inner) gripping element part connected thereto and a container held thereby.

In another preferred embodiment, the shaft and the motor shaft are formed as one piece. The shaft therefore represents a portion of the motor shaft located outside the motor housing. Alternatively, and also preferably since the replacement of parts in the event of a defect is simplified, the motor shaft is directly connected to the shaft via a coupling piece.

Preferably, a rail is arranged on the carrier, on which a carriage can slide which carries at least the first drive. Preferably, a shifting of the carriage on the rail causes a shifting of the shaft along its longitudinal direction.

The movement of the carriage is preferably determined by a control cam on which preferably a first contact element, preferably a roller of the carriage, slides and/or rolls. The carriage is preferably prestressed along the longitudinal direction of the shaft by a pressure application element, preferably a spring. This allows the contact element or roller to follow the shape of the control cam very reliably during operation.

The shaft is preferably rotatable about its longitudinal axis independent of the position of the carriage on the rail. Accordingly, the rotation of the shaft about its longitudinal axis is preferably also possible when the carriage is shifted on the rail by the shape of the control cam, for example raised or lowered.

Preferably, the sleeve is shiftable along its longitudinal direction and/or axis of rotation. Preferably, it is connected to a carriage that can slide on the rail of the carrier. The shifting of the carriage and therefore also of the sleeve is preferably carried out by a control cam on which a contact element, preferably a roller, can slide and/or roll. The carriage is preferably prestressed along the longitudinal direction of the sleeve by a pressure application element, preferably a spring, to ensure that during operation, the contact element rests on the control cam and precisely follows its shape.

Preferably, the gripping element has a coupling region in a portion located within the clean room. In this coupling region, the shaft and/or the sleeve can be detachably connected to a gripping element. This embodiment makes it possible to replace the gripping element in the event of a defect or to exchange it for another gripping element that is suitable and configured to grip a different type of container. Preferably, the gripping element is specific for gripping a certain type of container and/or several types of containers with partially identical geometry (for example in the threaded region and/or the mouthpiece). For this purpose, for example, a diameter of an inner gripping element part can be adapted to an inner diameter of the threaded region of the container to be gripped.

Preferably, the gripping element comprises an outer gripping element part and an inner gripping element part. Preferably, the outer gripping element part encloses the inner gripping element part at least in portions. In particular, it is preferred that the inner gripping element part can be coupled to the shaft, and the outer gripping element part can be coupled to the sleeve. This makes it possible to transfer relative movements between the shaft and the sleeve also to the gripping element, in particular the inner gripping element part and the outer gripping element part, and therefore to configure them relatively movable to one another.

In a preferred embodiment, the relative movement between shaft and sleeve and/or between outer gripping element part and inner gripping element part is a movement along and/or in a longitudinal direction of the plastics containers or plastics preforms. Preferably, the relative movement is a movement in a vertical direction.

Particularly preferably, the inner gripping element part is a holding mandrel which can be inserted into a mouth of a container, for example a plastics preform, in working operation in order to hold the container or the plastics preform in this way.

Preferably, the gripping element comprises a sealing element which delimits an intermediate space lying between the inner gripping element part and the outer gripping element part from the clean room. The intermediate space is preferred because it promotes the relative movement between the inner gripping element part and the outer gripping element part. It could be filled with a lubricant, at least in portions. The sealing element ensures that contaminants from this intermediate space cannot enter the clean room. Preferably, the sealing element is a flexible collar, preferably a bellows, which has proven to be particularly suitable for enabling the relative movement between the inner gripping element part and the outer gripping element part.

Preferably, a sealing device is provided in a region of the clean room wall in which the shaft and/or the sleeve penetrate the clean room wall. The sealing device is preferably ring shaped and more preferably extends along the circumferential direction around the shaft and/or the sleeve. Preferably, the sealing device completely bridges an intermediate space that is formed between the edges of a recess in the clean room wall and the shaft or sleeve.

Preferably, the sealing device comprises a ball bearing which is arranged in a region between the shaft and/or sleeve and a flexible collar, one end of which is firmly connected to the clean room wall. In a preferred embodiment, the flexible collar could be configured as a bellows.

The ball bearing preferably surrounds the sleeve and/or the shaft in a ring shape along their entire circumference. The ball bearing is preferably shiftable together with the sleeve and/or the shaft along the longitudinal direction of the sleeve and/or the shaft. Preferably, only an inner ball bearing portion is rotatable with the sleeve and/or the shaft. An outer ball bearing portion is preferably not rotatable with respect to the clean room wall.

Preferably, the sleeve is widened in the region of its clean-room-side end (in the radial direction). Preferably, a projection or several projections are arranged in this widened region. These preferably form a groove which can receive a complementary locking element of the gripping element, preferably the outer gripping element part. The locking element preferably engages in a form fit in this groove so that a movement of the sleeve can be transmitted to the locking element. The movement to be transmitted can be a rotation or translation (in particular along the longitudinal direction of the sleeve).

The shaft preferably has a recess in a clean-room-side end portion. This recess is preferably designed and configured to at least in portions receive a complementarily configured portion of the inner gripping element part. The portion of the inner gripping element part to be received is preferably a portion of a coupling rod. In particular, it is preferred that the coupling rod can be fixed in the recess by a bayonet lock. For this purpose, the recess preferably has at least one longitudinal slot and a transverse slot adjoining the longitudinal slot (at its end arranged along the side of the shaft facing away from the clean room). The coupling rod preferably has at least one corresponding projection or pin which can slide in these slots. After inserting the shaft with the pin along the longitudinal slot and then rotating the coupling rod with the pin along the transverse slot, the pin preferably comes into a locking position, whereby the shaft is connected in a form fit to the coupling rod, and a transmission of the movement of the shaft (rotational and/or translational) to the coupling rod and therefore to the inner gripping element part is made possible.

Preferably, the connection between the shaft and/or sleeve and the gripping element (or the inner gripping element part and/or the outer gripping element part) can be released without tools.

Preferably, the connection between the sleeve and the outer gripping element part is made at a radial distance from the axis of rotation of the sleeve which differs from a radial distance of the connection of the shaft to the inner gripping element part from the axis of rotation of the shaft. The connection between the sleeve and the outer gripping element part on the one hand and the shaft with the inner gripping element part on the other hand is therefore preferably made at different positions with respect to the axis of rotation of the shaft (and the sleeve). This makes it possible to release both connections separately from one another.

The inner gripping element part preferably comprises a holding portion which is configured to contact a container. The holding portion can preferably be inserted into a container at least in portions. Preferably, the inner gripping element part comprises a spreading element by which the holding portion can be applied with pressure at least in portions in order to press it against a container wall, preferably an inner wall of the container. The portion of the container wall is particularly preferably a threaded portion and/or a portion of a mouthpiece of the container.

Preferably, a portion of the inner gripping element part is shiftable with respect to a portion of the outer gripping element part. Particularly preferably, the holding portion can be transferred from a first state in which it projects beyond the portion of the outer gripping element part to a second state in which it does not project beyond the portion of the outer gripping element part. Preferably, the portion of the inner gripping element part is the one holding portion which is configured to contact a container. However, it would also be conceivable (in addition or as an alternative) that, by shifting the portion of the inner gripping element part with respect to a portion of the outer gripping element part, the holding portion is only deformed in such a way (for example, narrowed in the radial direction) that the pressure applied to the container is no longer sufficient to hold the container.

Furthermore, the present invention relates to a transport device with at least one gripping device as described above. The transport device preferably has a movable transport element on which at least one, preferably a plurality of the gripping devices is/are arranged. Preferably, the carrier of the gripping device is (firmly) connected to the transport element. Preferably, a transport device comprises between 8 and 1024, preferably between 16 and 646 gripping devices.

The movable transport element can preferably be a rotatable transport element or a circulating transport element such as a transport chain. In the case of a rotatable transport element, it is preferred that it is rotatable about a central axis and therefore preferably forms a transport starwheel. Preferably, the at least one gripping device can be guided along a circular path by the movable transport element.

In combination with the above-described possibility of rotating a gripping element of the gripping device, it is possible to align a transported container during its transport with respect to the transport path, the transport device and/or a treatment device such as a heating device and/or a forming device. If the transport device is a transport starwheel, a so-called container orientation starwheel is formed. Analogously, such an embodiment is also possible when the transport element is configured as a circumferential transport element such as a transport chain.

In a preferred embodiment, the movable transport element forms at least a portion of a clean room wall. In this regard, it is conceivable, for example, that the transport element is a rotating disk, above which (and therefore outside the clean room) a carrier of the gripping device is arranged, wherein the sleeve and/or shaft penetrate the clean room wall or the disk, and below the disk (and therefore inside the clean room), the gripping element guides a container.

Preferably, a transport device has at least one control cam on which at least one contact element of a gripping device is guided. Preferably, the control cam is connected at least in portions to the shaft (or an element carrying the shaft, such as a carriage) via the contact element. This preferably makes it possible to move the shaft along the longitudinal direction thereof depending on the shape of the control cam. The control cam therefore preferably predetermines the relative movement of the shaft (and possibly also of the gripping element and/or a sleeve) with respect to the carrier.

Preferably, a transport device has at least two control cams, on each of which at least one contact element of a gripping device is guided. This makes it possible to specify the relative movement of a shaft and a sleeve (and, if applicable, a gripping element arranged on the shaft and/or sleeve) with respect to the carrier independently of one another. This is particularly advantageous in order to control (for example as described above) a movement of gripping element parts with respect to one another and therefore to specifically trigger and/or mechanically support the picking up and/or dropping off of a container.

The transport device preferably has a drive by which a movement of the movable transport element can be controlled. The drive device is preferably arranged outside the clean room.

In a preferred embodiment, the transport device comprises a distribution device. Such a distribution device preferably serves to transmit a medium and/or a signal from an immovable part of the transport device to a device that is movable with the transport element.

A medium can be a fluid, for example. Its movement and/or pressure can preferably be used to control an actuator, for example the gripping device. Such an actuator of the gripping device can be, for example, a hydraulic cylinder, a motor or another drive. Such an actuator can, for example, initiate or carry out a container treatment which is preferably selected from a group comprising its rotation, transport, alignment, shifting, deformation and temperature change. Alternatively or in addition thereto, it is also conceivable that the actuator triggers a movement of the gripping element (or a part of the gripping element), for example to grip a container or to release it.

The signal which can be transmitted by the distribution device from an immovable part of the transport device to a device movable with the transport element is preferably an electrical signal which is preferably transmitted via a cable. The signal can, for example, actuate a motor. A motor that can be actuated by the signal is preferably operatively connected to a shaft and/or sleeve as described above so that a rotation generated by the motor can be transmitted to the shaft and/or sleeve.

Preferably, the transport device is part of a container treatment system. This container treatment system can, for example, be provided and configured to transform containers (e.g., preforms) into containers of a different geometry, and/or to apply temperature to the container, and/or to apply a mark to the container.

Because the gripping device preferably allows an alignment of the container with respect to its longitudinal direction, the position and/or alignment of the container with respect to the carrier can be adjusted. This in turn makes it possible for a specific container region to be providable with a temperature and/or a mark (for example a print and/or a label) and/or for the container to be fed to a forming device (preferably a stretch blow molding device) in a certain predetermined orientation.

In a preferred embodiment, such a container treatment system comprises several transport devices as described above. This allows multiple alignment of the containers and any necessary readjustment of the container alignment before a specific treatment process. For example, a container can thereby be provided with a specific temperature profile, then subjected to a forming process in a predetermined orientation and then, if necessary, provided with a mark at predetermined positions.

Furthermore, the present invention relates to a method for aligning a container along its longitudinal axis during its transport within a clean room. This method is characterized by the following steps:
shifting a gripping element arranged within a clean room with respect to a carrier by a second drive device arranged outside the clean room,
gripping a container by the gripping element,
rotating the container and the gripping element by a first drive device arranged outside the clean room,
transporting the container held by the gripping element through the clean room, and
transferring the container to a downstream container treatment device or container transport apparatus along the transport path.

On the one hand, this method allows a container to be rotated during its transport through a clean room and therefore to be correctly aligned for subsequent working steps. In addition, this method allows very easy maintenance since this method does not require the clean room to be opened if maintenance work has to be carried out on the first drive device arranged outside the clean room.

In particular, it is preferred that the container and the gripping element are rotated by a shaft arranged between the drive device and gripping element. The container preferably rotates about the same axis about which the shaft also rotates. This method variant has proven to be very advantageous with regard to precise alignment of the container.

In a preferred variant of the method, an inner gripping element part is moved with respect to an outer gripping element part which surrounds the inner gripping element part at least in portions. Preferably, the inner gripping element part is moved in the longitudinal direction thereof with respect to the outer gripping element part. Preferably, this relative movement is triggered by the second drive device. It is also conceivable that (alternatively or in addition thereto) a (possibly additional) relative movement is triggered by a further third drive device, preferably also arranged outside the clean room.

Preferably, the method for aligning a container along its longitudinal axis during its transport within a clean room can be carried out with all features described in the context of the gripping device and/or the transport device individually or in combination with one another. Conversely, the gripping device and/or the transport device is preferably configured, suitable and/or intended to carry out the method described above for aligning a container along its longitudinal axis during transport thereof within a clean room as well as all method steps described in connection with the method individually or in combination with one another or individual method steps while using them.

Further advantages and embodiments emerge from the accompanying drawings, in which:

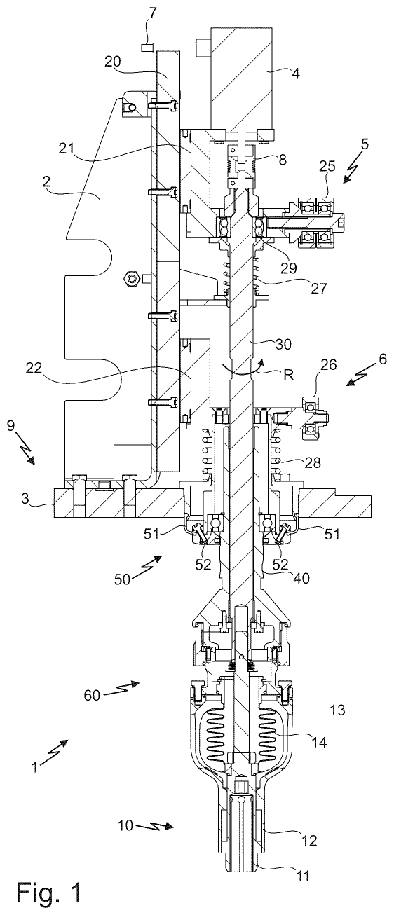

FIG. 1 shows a view of a gripping device according to the invention in a preferred embodiment;

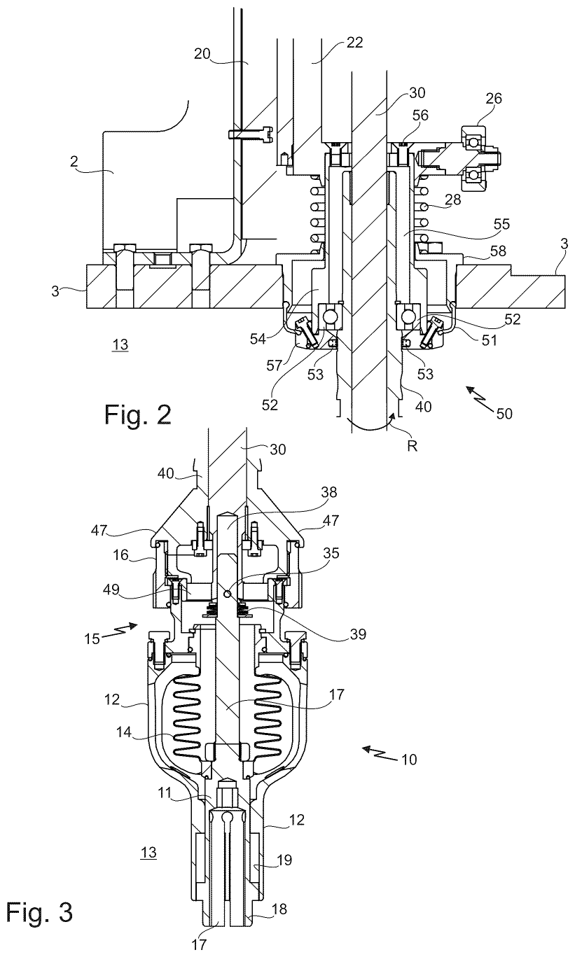

FIG. 2 shows a detailed view of the gripping device from FIG. 1 in the region of the sealing device; and

FIG. 3 shows a detailed view of the gripping device from FIG. 1 in the coupling region.

FIG. 1 shows a view of a gripping device 1 in a preferred embodiment. This representation is a sectional view in a plane that intersects a central axis of the shaft 30. The gripping device 1 has a carrier 2 which is firmly connected to a clean room wall 3. In the shown example, the gripping device has a first drive 4, a second drive 5 and a third drive 6.

The first drive 4 is preferably an electrically operated motor 4, the rotor shaft 31 of which lies in an extension of the shaft 30. The motor 4 is connected to a power supply device and/or control device via the cable 7. Preferably, the motor 4 is an actuator and/or servo motor. The rotor shaft 31 of the first drive 4 is operatively connected to the shaft 30 via a connecting element 8. The rotation of the rotor shaft 31 of the first drive 4 can be transmitted to the shaft 30 via the connecting element 8. If necessary, the connecting element 8 can offer stepping up or stepping down of the rotational movement, which can be advantageous in particular as stepping down for the precise positioning of the shaft 30 and therefore also of the (inner) gripping element part 11 connected thereto and a container held thereby (not shown).

The drive 4 and the shaft 30 are preferably shiftable together with respect to the carrier 2 by a carriage 21. To guide the carriage, a rail 20 is preferably arranged on the carrier, on which the carriage 21 can slide and which predetermines the direction of the shift of the carriage 21. Preferably, the carriage 21 is shiftable along the longitudinal direction of the shaft 30 or along the axis of rotation R of the shaft 30, i.e. along the height direction H in the shown example.

In the shown embodiment, the carriage 21 has a first roller 25 which represents a first contact element 25 to a control cam (not shown). The roller 25 preferably rolls on the control cam during the movement of the transport element 9 and shifts the carriage 21 in the height direction H according to the shape of a rolling surface of the control cam in the height direction H. During the process, the shaft 30 is preferably also shifted in the height direction H.

Preferably, the carriage 21 is prestressed along the height direction H by a first pressure application element 27, preferably a spring 27. This ensures that the contact element 25 or the roller 25 permanently contacts the control cam (not shown), can roll thereon, and follows the shape of the control cam during operation.

The shaft 30 is preferably rotatable about its longitudinal axis independently of its position. Accordingly, the rotation of the shaft 30 about its longitudinal axis (along or against the direction of rotation R) is preferably also possible when it is shifted along the height direction H, for example raised or lowered. The rotation is preferably ensured by the shaft 30 being guided at least in portions in a sleeve 40. The sleeve 40 preferably has a low frictional resistance on the inside against the shaft 30. If necessary, a lubricant can be arranged between sleeve 40 and shaft 30. This preferably seals a gap between shaft 30 and sleeve 40.

In the shown embodiment, the sleeve 40 is also shiftable along the height direction H. For this purpose, the sleeve is also connected to a carriage 22. The carriage 22 preferably also slides on a rail 20 arranged on the carrier 2, wherein in the shown example, only a single rail 20 is provided on which both carriages 21, 22 can slide.

The shifting of the carriage 22 along the height direction H is preferably carried out by a control cam (not shown). A contact element 26, which is preferably configured as a roller 26, can slide (or roll) along this and preferably shifts the carriage according to the geometry of the control cam along the height direction H. As also described above with respect to the carriage 21, it is preferred that the carriage 22 is also prestressed along the height direction H by a second pressure application element 28, preferably a spring 28. The initial stress ensures that, during operation, the roller 25 rests on the control cam (not shown) and follows its shape precisely.

The sleeve 40 is preferably rotatable with respect to the carriage 22. For this purpose, a ball bearing 52 is preferably provided which contacts both the carriage 22 as well as the sleeve 40 and allows the rotation of the sleeve 40 with respect to the carriage 22 with as little friction as possible.

The rotation of the sleeve 40 with respect to the carriage 22 can also allow the rotation of the shaft 30 (about the axis of rotation R) with respect to the carriages 21, 22. It is therefore conceivable that the shaft 30 cannot rotate with respect to the sleeve 40, or only with increased effort. Nevertheless, rotation of the shaft by the drive 4 is possible since shaft 30 and sleeve 40 can be rotated together with respect to the carriage 22. This rotation is possible with little friction thanks to the ball bearing 52.

Preferably, in the region of the ball bearing 52, a sealing device 50 is also located which forms a clean room boundary 3. The ball bearing 52 can be part of the sealing device 50. A preferred embodiment of this clean room boundary 3 in the region of the ball bearing and the sleeve 40 and shaft 30 which is movable with respect to the clean room boundary 3 is described and illustrated in detail in connection with FIG. 2.

Within the clean room 13, the gripping element 1 in the shown embodiment has a coupling region 60. In this region, shaft 30 and sleeve 40 can be separated from a gripping element 10. This makes it possible, for example, to replace the gripping element in the event of a defect or to exchange it for another gripping element 10 which is suitable and configured for gripping a different type of container (not shown).

Preferably, a gripping element 10 comprises an inner gripping element part 11 and an outer gripping element part 12. The geometry of these gripping element parts 11 and 12 can differ for various gripping elements in order to configure the gripping element for gripping different containers. Preferably, the outer gripping element part 12 encloses the inner gripping element part 11 at least in portions. In particular, it is preferred that the inner gripping element part 11 can be coupled to the shaft and the outer gripping element part 12 can be coupled to the sleeve 40. This makes it possible to also transfer the relative movements between shaft 30 and sleeve 40 to the inner gripping element part 11 and the outer gripping element part 12 and therefore to configure them to be relatively movable with respect to one another.

In order to allow the relative movement between the inner gripping element part 11 and the outer gripping element part 12 without contaminants being able to enter the clean room, a sealing element 14 is preferably provided between them. This sealing element 14 is preferably configured as a flexible collar, preferably as a bellows 14.

FIG. 2 shows a detailed view of the gripping device from FIG. 1 in the region of the sealing device 50. The sealing device 50 is preferably arranged in the region of an interruption in the clean room wall 3 through which the shaft 30 and/or the sleeve 40 (in the shown example, shaft 30 and sleeve 40) penetrate the clean room wall 3.

In order to maintain the sterility of the clean room 13 despite this penetration of the clean room wall 3, the sealing device 50 is provided in the region of the opening of the clean room wall 3. This is preferably arranged in a ring shape around the shaft 30 and/or the sleeve 40 and bridges an intermediate space which is formed between the edges of a recess in the clean room wall 3 and the shaft 30 or the sleeve 40.

An insert part 58 is preferably inserted into the recess in the clean room wall 3. This closes the sealing device 50 preferably on the outside from the clean room wall 3. In order to ensure tightness at the contact point between the insert part 58 and the clean room wall 3, a bead of the collar 51 is preferably arranged in this region. This collar 51 is preferably made of a flexible material such as a plastics material or rubber so that the bead can function as an O-ring or seal. Preferably, it is at least partially compressed between the insert part 58 and the clean room wall 3. This results in an improved seal of the clean room boundary and at the same time secure fixation of the collar 51.

Outside the clean room, the second pressure application element 28 or the second spring 28 preferably rests on the insert part 58. It prestresses the second carriage 22 so that its second contact element 26 or the second roller 26 is securely guided on the control cam (not shown). As described in connection with FIG. 1, the second carriage 22 is guided on a rail 20 which is fastened to a carrier 2 connected to the clean room wall 3. The rail allows the directional shift of the carriage along the height direction H.

The carriage 22 is firmly connected to a housing 54, which surrounds the sleeve 40, via a connecting element 56, in this case a screw 56. The housing 54 therefore forms a part of the carriage 22, at least with respect to its movement along the height direction H. There is preferably a free space 55 between the housing 54 and the sleeve 40, whereby the friction of the sleeve during its rotation with respect to the carriage 22 or the housing 54 is minimized.

In order to be able to very securely and yet smoothly guide the rotation of the sleeve 40 with respect to the housing 54, a ball bearing 52 is preferably arranged between the sleeve 40 and the housing 54. This ball bearing 52 preferably surrounds the sleeve 40 in a ring shape along its entire circumference. Preferably, the ball bearing 52 forms a lower (or clean-room-side) end of the free space 55.

In order to transmit a movement of the carriage 22 to the sleeve, which movement is predetermined by the control cam, the ball bearing 52 with its part facing away from the sleeve 40 (and therefore the part which is movable with respect to the sleeve) is connected to a ring element 57 which is firmly connected to the housing 54. This ring element also surrounds the sleeve 40 in a ring shape, but without fixing the sleeve 40. As a result, the sleeve 40 remains relatively movable, in particular rotatable, with respect to the ring element 57. The region between the sleeve 40 and the ring element 57 is preferably sealed by a seal 53, for example an O-ring 53. When the sleeve rotates with respect to the housing 54 and the ring element 57, the sleeve slides along the O-ring 53. In so doing, this seal 53 prevents contaminants from being able to enter the clean room.

The tightness between the ring element 57 and the clean room wall 3 is ensured by the collar 51 already described above. This is preferably not rotatable about the axis of rotation R of the sleeve 40 or the shaft 30. Preferably, however, it is so flexible that the portion connected to the ring element 57 can follow the movement of the ring element 57 and therefore also of the sleeve 40 along the height direction H. This portion of the collar 51 can therefore be moved along the height direction H with respect to that portion of the collar which is fixed between the insert part 58 and the clean room wall 3 by at least partial compression. In order to allow a stronger relative movement of these parts with respect to one another and yet to be able to permanently ensure the seal, an embodiment is preferred in which the collar 51 is configured as a bellows 51. Such a bellows 51 can offer an additional material reserve through the fold(s), which ensures a seal in this region even in the event of strong shifts along the height direction H.

FIG. 3 shows a detailed view of the gripping device 1 from FIG. 1 in the coupling region 60. The connection between sleeve 40 and shaft 30 on the one hand and the gripping element 10 on the other hand preferably takes place in the region of this coupling device 60.

In order to increase the space available for the mechanical coupling, it is preferred that the sleeve 40 is widened in the coupling region 60 (in the radial direction). In this widened region of the sleeve 40, there is a projection 47 or several projections 47, each of which can receive complementary locking elements 16 of the outer gripping element part 12. Preferably, the locking elements 16 engage in the recesses formed by the projections 47. The projections 47 can be a plurality of separate projections 47 or can be formed by a single projection 47 surrounding the sleeve 40.

By coupling the sleeve 40 via the projections 47 to the locking elements 16 of the outer gripping element part 12, it is possible to transfer the movements of the sleeve 40 to the outer gripping element part 12. These movements can be a rotation (about the axis of rotation R, not shown here) as well as a longitudinal shifting (along the height direction H, not shown here).

In the region of the clean-room-side end of the sleeve 40, an end plate 49 is preferably provided which delimits a free space formed by the projections 47. This end plate 49 preferably has a central opening through which the shaft 30 and/or a coupling rod 17 of the inner gripping element part 11 can pass. Any intermediate space that may exist between the shaft 30 and/or coupling rod 17 on the one hand and the end plate 49 on the other hand is preferably bridged by a sealing element such as a bellows 39 in order to ensure the tightness of the clean room 13 during a relative movement of the shaft 30 and/or coupling rod 17 with respect to the end plate 49.

In order to transmit the movement of the shaft 30 to the coupling rod 17 and therefore to the inner gripping element part 11, it is provided in the shown preferred embodiment that the shaft has a recess 38 in its clean-room-side end, which can receive a portion of the coupling rod 17. Preferably, the coupling rod 17 can be fixed in the recess by a bayonet lock 15. Such a bayonet lock 15 is preferred because it can transmit the movement of the shaft 30 to the coupling rod 17 and therefore also to the inner gripping element part 11. For this purpose, the coupling rod 17 preferably has a pin 35 or several pins 35, which can be guided in the region of the recess 38 in corresponding longitudinal slots and transverse slots (in the shown sectional view outside the plane of the drawing) in the wall of the shaft 30. After the insertion of the pins 35 into the recess 38 along the longitudinal slots and the subsequent rotation of the shaft 30 with respect to the coupling rod 17, the pins slide along the transverse slots into a locking position so that a form-fitting connection is established between shaft 30 and the coupling rod 17. This allows a transmission of the movements of the shaft 30 (about the axis of rotation as well as along the height direction) to the inner gripping element part 11.

A detachable connection as described above both between the sleeve 40 and the outer gripping element part 12 as well as between the shaft 30 and the inner gripping element part 11 allows the relative movement generated outside the clean room between the shaft 30 and the sleeve 40 to be transmitted to the inner gripping element part 11 and the outer gripping element part 12. In addition, the described embodiment also offers the possibility of decoupling the inner gripping element part 11 from the shaft 30 and the outer gripping element part 12 from the sleeve and therefore releasing the entire gripping element 10. This simplifies an exchange of one gripping element 10 for another gripping element 10 and is preferably even possible without tools.

As explained above, the coupling between the sleeve 40 and the outer gripping element part 12 preferably takes place at a different radial distance from the axis of rotation than the coupling of the shaft 30 to the inner gripping element part 11. In order to keep the weight of the outer gripping element part 12 as low as possible despite the comparatively large radius, its outer wall is preferably not designed with a full-surface but has openings. In particular, it is preferred that the outer gripping element part 12 forms a space through which the coupling rod 17 extends in portions, wherein the space is preferably defined by webs between which recesses are arranged. In order to nonetheless avoid contamination of the clean room (for example due to abrasion or other contaminants between the inner gripping element part 11 and the outer gripping element part 12), the inner gripping element part 11 is preferably secured against the outer gripping element part 12 by a bellows 14.

The inner gripping element part 11 preferably comprises a holding portion 18 which forms the contact surface 18 to a container to be received. This can preferably be inserted into a container at least in portions and, for example, apply pressure to a threaded portion and/or a mouthpiece of the container from the inside. For this purpose, the contact surfaces 18 are pressed against the inner wall of the container by a spreading element 17.

If a container is held by the inner gripping element part 11, it can be rotated along the axis of rotation R (not shown in FIG. 3). This allows for precise alignment of the container with respect to its longitudinal axis. By transmitting the rotation of the shaft 30 generated outside the clean room 3 as described above and transmitting this movement via the coupling region 60 to the gripping element 10 located inside the clean room 3 or the inner gripping element part 11, very precise actuation and transmission of the rotational movement to the container is possible.

If a held container is to be dropped off, it can be shifted along the height direction H and/or the longitudinal direction of the shaft 30 by the relative movement of shaft 30 and sleeve 40 as described above or the analogous relative movement of the inner gripping element part 11 with respect to the outer gripping element part 12. For this purpose, a receptacle 19 is preferably formed by the outer gripping element part 12 into which the contact surfaces 18 of the inner gripping element part 11 can be retracted. In this case, any held container is initially moved in this direction, but is then however stopped in its movement because its mouthpiece and/or threaded portion abuts the walls of the receptacle 19. As the inner gripping element part 11 and therefore also the contact surfaces 18 are further retracted, the pressure applied by the contact surfaces 18 is constantly reduced until this force is no longer sufficient to support the container. At this point in time, the container is released from the gripping device and can, for example, be taken over by a transport device downstream along the transport path.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

### LIST OF REFERENCE SIGNS

1 gripping device
2 carrier
3 clean room wall, clean room boundary
4 first drive, motor
5 second drive
6 third drive
7 cable
8 connecting element
9 transport element
10 gripping element
11 inner gripping element part, inner gripper, mandrel
12 outer gripping element part
13 clean room
14 sealing element, flexible collar, bellows
15 bayonet lock
16 locking element
17 spreading element
18 holding portion, contact surface
19 receptacle 20 rail
21 first carriage
22 second carriage
25 first contact element, first roller
26 second contact element, second roller
27 first pressure application element, first spring
28 second pressure application element, second spring
29 ball bearing
30 shaft
31 rotor shaft
35 (spring-loaded) pin, projection, bolt
38 recess
39 sealing element, bellows
40 sleeve
47 projection, projections
49 end plate
50 sealing device
51 collar, bellows
52 ball bearing
53 seal, O-ring
54 housing
55 free space
56 connecting element, screw
57 ring element
58 insert part
60 coupling region
H height direction
R axis of rotation of the shaft

1. A gripping device comprising:
a carrier,
a gripping element which is movable with respect to the carrier for gripping a container during transport thereof along a transport path arranged at least in portions inside a clean room,
a first drive device configured for rotating a shaft connected to a gripping element, and
at least one second drive device configured for shifting the gripping element with respect to the carrier,
wherein the first drive device and the second drive device are arranged outside the clean room,
wherein
a clean room boundary extends between the carrier and the gripping element, which boundary is formed at least in portions by an at least partially movable sealing device, which allows the transmission of a movement pulse generated outside the clean room from both the first drive device and the second drive device to the gripping element arranged inside the clean room while maintaining the clean room boundary.

2. The gripping device according to claim 1, wherein
the shaft rotatable by the first drive device is shiftable with respect to the carrier in its longitudinal direction, wherein the shaft is preferably surrounded at least in portions by a sleeve which is preferably shiftable in the longitudinal direction the shaft with respect to the carrier, wherein the shaft and the sleeve are preferably shiftable independently of one another with respect to the carrier along the longitudinal direction of the shaft.

3. The gripping device according to claim 1, wherein any
the gripping element has an inner gripping element part and an outer gripping element part which surrounds the inner gripping element part at least in portions, wherein these two gripping element parts are movable with respect to one another along the longitudinal direction of the inner gripping element part.

4. The gripping device according to claim 1, wherein
the sealing device has a flexible collar, preferably a bellows, which has a first portion which is immovable with respect to the carrier when the gripping device is in the operating state and another second portion which is movable with respect to the carrier when the gripping device is in the operating state, preferably shiftable in the longitudinal direction of the shaft.

5. The gripping device according to claim 1, wherein
the sealing device comprises a ball bearing which is arranged between the shaft or a sleeve surrounding this shaft and a part which is immovable with respect to the carrier, preferably the clean room wall.

6. A transport device with at least one gripping device according to claim 1, wherein the transport device preferably has a movable transport element on which at least one, preferably a plurality of the gripping devices is/are arranged.

7. The transport device according to claim 6, wherein
the at least one gripping device is configured to be guided along a circular path by the movable transport element, wherein the movable transport element forms at least a portion of a clean room wall.

8. The transport device according to claim 6, wherein
at least one control cam, preferably at least two control cams, on which at least one contact element of a gripping device is guided, which specifies the relative movement of the gripping element, a shaft and/or a sleeve with respect to the carrier.

9. A method for aligning a container along its longitudinal axis during the transport thereof within a clean room,
comprising the steps:
shifting a gripping element arranged within a clean room with respect to a carrier by a second drive device arranged outside the clean room,
gripping a container by the gripping element,
rotating the container and the gripping element by a first drive device arranged outside the clean room, preferably about a shaft arranged between the drive device and the gripping element,
transporting the container held by the gripping element through the clean room, and
transferring the container to a downstream container treatment device or container transport apparatus along the transport path.

10. The method according to claim 9, wherein
an inner gripping element part is preferably moved in its longitudinal direction with respect to an outer gripping element part which surrounds the inner gripping element part at least in part, wherein this relative movement is preferably triggered by the second drive device and/or a further third drive device which is preferably also arranged outside the clean room.

11. The gripping device according to claim 2, wherein
the gripping element has an inner gripping element part and an outer gripping element part which surrounds the inner gripping element part at least in portions, wherein these two gripping element parts are movable with respect to one another along the longitudinal direction of the inner gripping element part.

12. The gripping device according to claim 2, wherein
the sealing device has a flexible collar, preferably a bellows, which has a first portion which is immovable with respect to the carrier when the gripping device is in the operating state and another second portion which is movable with respect to the carrier when the gripping device is in the operating state, preferably shiftable in the longitudinal direction of the shaft.

13. The gripping device according to claim 2, wherein
the sealing device comprises a ball bearing which is arranged between the shaft or a sleeve surrounding this shaft and a part which is immovable with respect to the carrier, preferably the clean room wall.

14. The transport device according to claim 7, wherein
at least one control cam, preferably at least two control cams, on which at least one contact element of a gripping device is guided, which specifies the relative movement of the gripping element, a shaft and/or a sleeve with respect to the carrier.

15. The gripping device according to claim 3, wherein
the sealing device has a flexible collar, preferably a bellows, which has a first portion which is immovable with respect to the carrier when the gripping device is in the operating state and another second portion which is movable with respect to the carrier when the gripping device is in the operating state, preferably shiftable in the longitudinal direction of the shaft.

16. The gripping device according to claim 3, wherein
the sealing device comprises a ball bearing which is arranged between the shaft or a sleeve surrounding this shaft and a part which is immovable with respect to the carrier, preferably the clean room wall.

17. The gripping device according to claim 4, wherein
the sealing device comprises a ball bearing which is arranged between the shaft or a sleeve surrounding this shaft and a part which is immovable with respect to the carrier, preferably the clean room wall.
